(19) United States
(12) Patent Application Publication
(10) Pub. No.: US 2008/0221865 A1
(43) Pub. Date: Sep. 11, 2008

(54) Language Generating System

(76) Inventor: Harald Wellmann, Hamburg (DE)

Correspondence Address: THE ECLIPSE GROUP, 10605 BALBOA BLVD., SUITE 300, GRANADA HILLS, CA, 91344, US

(21) Appl. No.: 11/616,279

(22) Filed: Dec. 26, 2006

(30) Foreign Application Priority Data
Dec. 23, 2005 (EP) 05 028 402.5

(51) Int. Cl. G06F 17/28; G10L 13/00

(52) U.S. Cl. 704/8; 704/E13.001

(57) ABSTRACT

A Language Generating System (“LGS”) for generating and outputting natural language data for informing a user of a predetermined event in a plurality of different languages, is provided. The LGS may include a database including grammar data sets corresponding to each of a plurality of languages, the grammar data including transformation rules that may be used to obtain a sequence of words having an information content corresponding to the predetermined event. In addition, a universal speech driver may be provided, which constructs a grammatically correct sequence of words having the information content corresponding to the predetermined event on the basis of a grammar data set. The language generating system may additionally include an information unit that may generate an auditory output to via, for example, a loudspeaker, or a visual output via, for example, a display.

### RELATED APPLICATIONS

This application claims priority of European Application Serial Number 05 028 402.5, filed on Dec. 23, 2005, entitled SPEECH GENERATING SYSTEM; which is incorporated by reference in this application in its entirety.

### BACKGROUND OF THE INVENTION

1. Field of the Invention

This invention relates to a system and method for generating language data. More specifically, the invention relates to a system and method for generating and outputting natural language data, such as, for example, in the context of vehicle navigation systems.

2. Related Art

Motor vehicle navigation systems (also referred to as “navigation systems”) are known and are increasingly offered in new vehicles for guiding the driver of the vehicle from a present location to a destination location. In many such known systems, the guiding is done by providing instructions to the driver prior to reaching an upcoming location. For example, the navigation system may instruct the driver to turn right at the next traffic light (e.g. “turn right in 200 meters”, or “please exit the highway at junction 15”). In addition to these oral driving instructions, known navigation systems may provide a driver with information relating to the operating state of the navigation system itself. For example, after a user inputs an originating and destination location, the navigation system may inform the user that the new route has been computed.

In prior art navigation systems, each route is generally associated with a well-defined set of events, where each set of events corresponding to a plurality of parameters. For example, the parameters may include distances, road names, directions, status, alternative directions. Additionally, the different events are language-independent. This means that even when the system supports multiple languages, which is the case in many existing navigation systems, the information to be output to the driver has the same information content. In prior art navigation systems, the number of events and parameter types stored in an auditory file is relatively small compared to the number of possible combinations of events and parameter values. As a consequence, a complete enumeration of events is not feasible. Accordingly, in commonly utilized navigation systems, only a small fraction of all possible events may be stored in the navigation system itself. In order to address this problem, announcements or instructions are constructed from small speech fragments recorded from different speakers. The recorded fragments are generally small, commonly-used words, phrases or sounds, and are stored in a data base in the navigation system.

In a navigation system with such stored recorded speech fragments, announcements or instructions are constructed from a sequence of words, speech fragments, morphemes or sounds, a morpheme being the smallest unit of grammar consisting either of a word or a part of a word. In prior art systems for each supported language of the navigation system, there is a speech driver that builds a morpheme sequence for the needed combination of events and parameters. A speech engine takes the morpheme sequence and plays the corresponding speech fragments to produce an announcement or instructions.

The prior art speech engine is language-independent; however, the speech drivers are language-dependent so that one speech driver is provided for each language. As a result, when the navigation system is used together with a new language, each new language requires a new software release with additional drivers. This causes the implementation of an additional language expensive and complicated.

FIG. 1 illustrates a prior art navigation system as described above. The system includes a control unit 10 that controls the functioning of the navigation system. A language ID signal controls the selection of the different speech drivers 11, 12, 13, depending on the language of the announcement or instruction—in this example, either French, English or German, respectively. The announcements or instructions are constructed from speech fragments that are stored in data bases 11a, 12a, and 13a that include the data for the respective languages. The speech drivers 11, 12, 13 build the announcement or instruction as a sequence of the speech fragments stored in the data basis 11a, 12a, or 13a. Each speech fragment may have a unique ASCII representation. Furthermore, a speech engine 14 is provided which takes the constructed sequence of speech fragments and plays the corresponding speech fragments to produce an announcement or instructions that are output by the loudspeaker 15. Because there is one speech driver for each language, when the prior art navigation system of FIG. 1 is to be equipped with a new language, a new speech driver for that language is required. This results in the implementation of new languages being costly.

Accordingly, a need exists to provide a language generating system that is able to inform a user of a sequence of words, speech fragments, phrases, sounds or morphemes in an easy and cost-effective way.

### SUMMARY

A Language Generating System (“LGS”) for generating and outputting natural language data for informing a user of a predetermined event in a plurality of different languages is described. The LGS may include a database that includes grammar data sets corresponding to each of a plurality of languages, the grammar data including transformation rules that may be utilized to obtain a sequence of words having an information content corresponding to the predetermined event. In addition, a universal speech driver may be provided, which constructs a grammatically correct sequence of words having the information content corresponding to the predetermined event on the basis of a grammar data set. The LGS may additionally include an information unit that may generate an auditory output via, for example, a loudspeaker, or a visual output via, for example, a display.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 shows a block diagram of a known speech generating system.

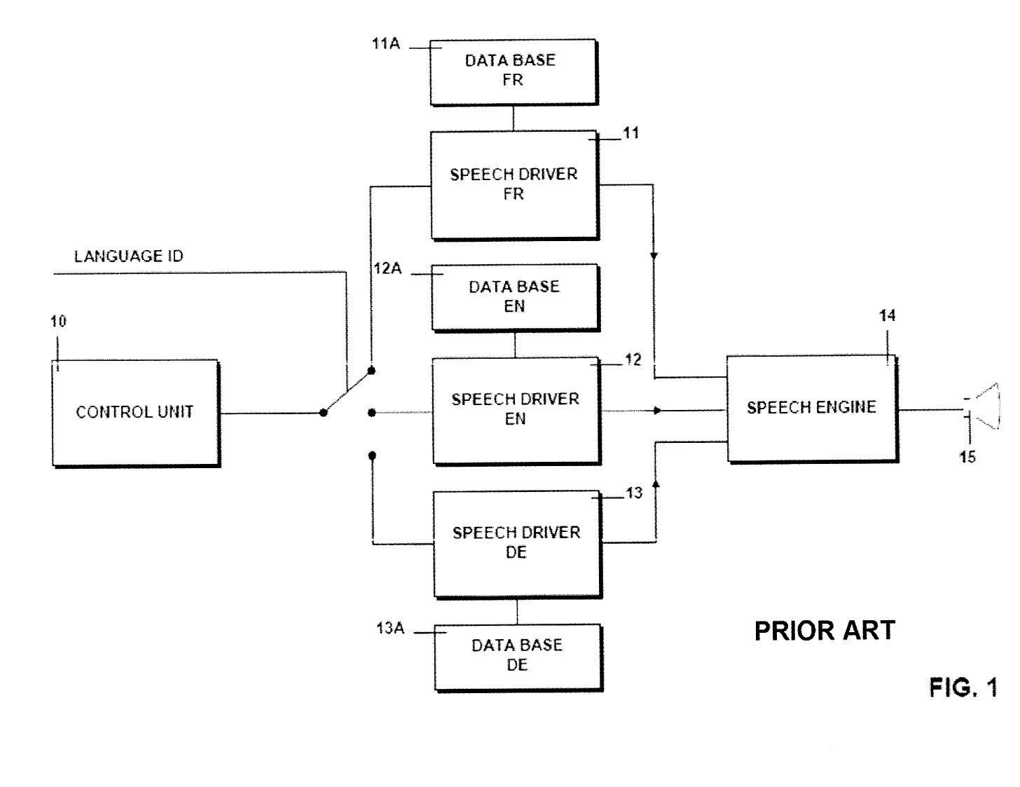

FIG. 2 shows a block diagram of an example of an implementation of a Language Generating System (“LGS”) having a universal speech driver.

FIG. 3 shows a diagram that illustrates different types of nouns.

FIG. 4 illustrates a flowchart showing example steps for generating a speech output in different languages using the universal speech driver.

### DETAILED DESCRIPTION

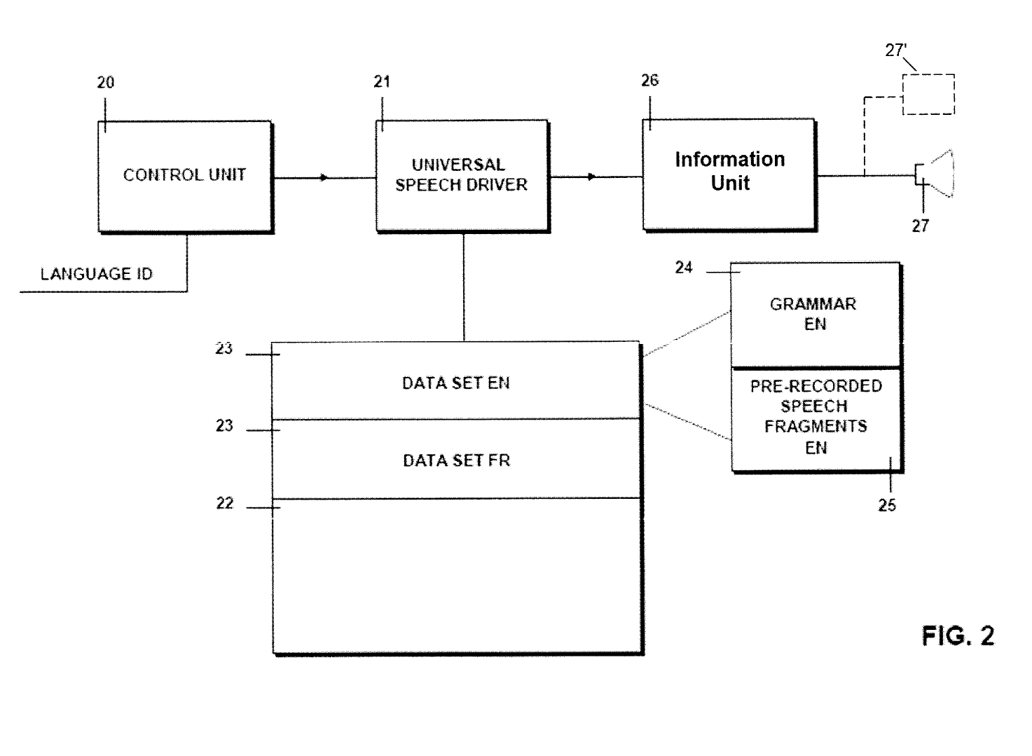

FIG. 2 illustrates an example of an implementation of a Language Generating System (“LGS”) having a universal speech driver 21. The LGS may include a main control unit 20 where the control unit 20 receives a language ID signal identifying the desired output language. The language ID signal may be input into the control unit 20 and then sent to the universal speech driver 21, or alternatively may be directly input into the universal speech driver 21. The universal speech driver 21 is a language-independent driver utilized to determine a sequence of words, sounds, speech fragments or morphemes (here collectively and individually referred to as “speech fragments”) having an information content corresponding to a predetermined event, set of events or parameters for the event(s) (which may be collectively or individually referred to as an “event”). The universal speech driver 21 constructs a grammatically correct sequence of words having the information content corresponding to a predetermined event or parameter on the basis of a grammar data set 23 (described further below) in a database 22 (described further below).

Each grammar data set 23 may include a plurality of predetermined speech fragments corresponding to a particular language. As explained below, the universal speech driver 21 may build sequences of words based on these predetermined speech fragments. The speech fragments may be morphemes. A morpheme is the smallest meaningful unit of grammar in a language and consists either of a word or a part of a word. For example, the word “dogs” consists of two morphemes and one syllable, a first morpheme “dog” and the second morpheme the plural “s”. It is appreciated by those skilled in the art that that the “s” may just be a single morpheme and does not have to be a whole syllable. In another example the word “technique” may consist only of one morpheme having two syllables. Even though the word has two syllables it is a single morpheme because it cannot be broken down into smaller meaningful parts. In another example the expression “unladylike” includes three morphemes, a first morpheme “un” having the meaning of “not”, the other morpheme “lady” having the meaning of a female adult human, and a third morpheme “like” having the meaning of “having the characteristic of”. None of these morphemes may be broken up any more without losing all sense of meaning. By storing morphemes in a given grammar data set 23, the morphemes may be utilized for generating the speech output.

Alternatively, other units of speech or grammar may be utilized as the predetermined speech fragments instead of, or in addition to, morphemes. These speech fragments or units may include several morphemes or may include several different words. It may be possible that a predetermined combination of words used only in a single context (or limited number of contexts) may be considered as one single unit or speech fragment. Accordingly, the speech fragments may be chosen based on the different context in which the speech fragment is used. When the speech fragment is used for different applications, the speech fragment may be the smallest possible unit (i.e., a morpheme), and in other situations, the speech fragment may consist of several words, particularly if the collection of words are used only in one context or a limited number of contexts. This dependency of the choice of the speech fragments on the used context or on the different possible applications may reduce the complexity of the grammar stored in any given grammar data set 23 of the database 22.

The universal speech driver 21 may then build a sequence of morphemes once the sequence of words is known. The information unit 26 may then take the morpheme sequence and, in the case of a speech engine or text-to-speech engine, play the corresponding speech fragments in order to produce the output speech data, and in the case of a text engine, display the morpheme sequence to the user.

The speech fragments, such as the morphemes, include in each grammar data set 23, may include machine-readable grammar data with no executable code. As described further below, the universal speech driver 21 may utilize the data in the grammar data sets 23 for constructing sequences of words through which a user may be informed of an event in a grammatically correct way. By providing multiple grammar data sets 23 in the language generating system, when it is desirable to generate natural language data in a new language, a new speech driver for the corresponding language is not necessary. By providing new grammar data sets in the database, the language generating system may be able to “speak” in the new language.

In order to generate the correct sequence of words in different languages, the universal speech driver 21 may use a database 22 that includes different grammar data sets 23. In the implementation shown in FIG. 2, each grammar data set 23 may include data to generate an announcement or instruction for one particular language (for example, English (“DATA SET EN”) or French (“DATA SET FR”)). The data in the grammar data set 23 may include transformation rules that may be used to obtain a sequence of words having an information content corresponding to the particular event. While French and English are illustrated, additional languages or alternative languages may be utilized.

As shown, each grammar data set 23 for a particular language may include grammar data 24 for defining a grammatical form of an announcement in the corresponding language. Each grammar data set 23 may additionally include pre-recorded words, speech fragments, morphemes or sounds 25 (referred to collectively, for convenience, as pre-recorded speech fragments 25) in the corresponding language, and stored in the language generating system. The pre-recorded speech fragments 25 may include a plurality of words, speech fragments, sounds or morphemes that may be used in combination to provide a user with an announcement or instructions, for example, turn right or left, continue straight, etc. The speech fragments may be recorded for each language by a native speaker of the language, so that when the announcement or instruction is output to the user, the user hears an announcement or instruction from a native speaker of the selected language.

It should be understood that the different grammars or the different speech fragments may also be stored in a different configuration. For example, the pre-recorded speech fragments 25 may be stored in the same database as the grammar 24. As another example, each grammar data set 23 may include both the grammar 24 and the corresponding pre-recorded speech fragments 25, within the grammar data set 23 itself. It is also possible that grammar or pre-recorded speech fragments used for constructing a sentence may be stored in a database remote from the speech generating system, rather than in the speech generating system itself. In this case, the LGS may access remote databases through a wireless communication network. For example, a speech generating system used in the context of a navigation system may include a telecommunication module allowing use of a cellular phone to communicate with one or more remote databases. In this case, a user may access a server which may be reached through the Internet. The server may include data for a new grammar data set 23 corresponding, for example, to a language not originally provided in the speech generating system itself, or updated data for a previously supplied grammar data set 23. The user may download the new grammar data set 23 to the language generating system. In an alternative implementation, the user may be asked to pay for, or register to access or obtain, the new language data 23, before a new grammar data set 23 can be downloaded. Transmission via wireless or wired communication systems allows the provision of new languages in an easy way.

Once the universal speech driver 21 has determined a sequence of words, speech fragments, sounds or morphemes based on the appropriate grammar data set 23, the sequence of words, speech fragments, sounds or morphemes is provided to an information unit 26. The information unit may include, for example, a speech engine which may use a sequence of words for generating a natural language speech output in any of the supported languages. The speech engine may generate the speech or auditory output based on a determined sequence of words, and provide the output to a loudspeaker 27 for auditory output to a user. According to another implementation of the invention, the information unit 26 may include a text engine, which may generate a textual output corresponding to a sequence of words. The textual output may then be output via a display 27′ so that the user is informed of the determined sequence of words by displaying a grammatically correct sequence of words. It is also possible that a user may be informed of the sequence of words both vie an auditory and textual output, i.e. a speech engine 26 may generates a natural language speech output via a loudspeaker 27, and a text engine may generate a corresponding textual construction of the same sequence of words and output the text on a display 27. The display 27 may be any known display such as, for example, a computer display, a built-in LCD display, a television screen, or a display on a PDA or telephone.

According to another implementation, the information unit 26 may include a text-to-speech engine that converts a determined sequence of words in a text format into a speech output. In this case the universal speech driver 21 may generate text, i.e. the sequence of words in text format, and the text-to-speech engine converts the sequence of textual words into speech fragments to be output as speech data via a loudspeaker 27.

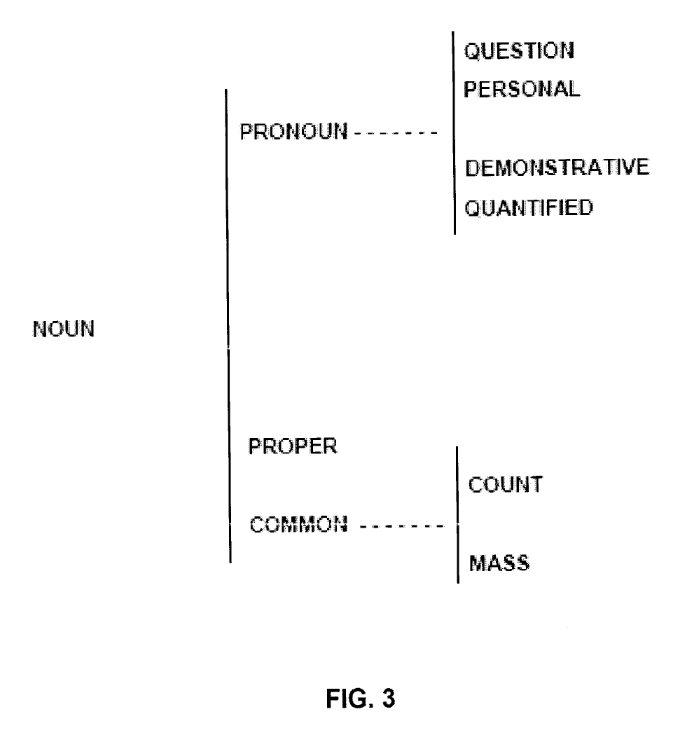

FIG. 3 shows a diagram that illustrates different types of nouns. As illustrated, a noun may be either a pronoun, a proper noun or a common noun. Generally, these three types of nouns are mutually exclusive. Thus, a choice between the features “question”, “personal”, “demonstrative”, “quantified” may only be relevant with respect to a pronoun type of noun, and not relevant with a proper or common noun. The system may thus forbid certain combinations of types of nouns and features. These transformation rules or functional grammatical descriptions, may be expressed using functional unification grammars (“FUGs”), as illustrated, for example, below:

( ( CAT NOUN )

(ALT ( ( ( NOUN PRONOUN )

( PRONOUN

( ( ALT ( QUESTIONS PERSONAL
DEMONSTRATIVE QUANTIFIED ) ) ) ) )

( ( NOUN PROPER ) )
( ( NOUN COMMON)

( COMMON ( ( ALT ( COUNT MASS ) ) ) ) ) ) ) )

Similarly, a portion of a grammatical description that may be used for generating an announcement for numbers in German language is illustrated below.

( ( CAT CARDINAL - NUMBER )

| | |
|---|---|
| ( POS1 GIVEN ) | ; ; PARAMETER POS1 IS |

MANDATORY; THE

PARAMETERS POS10, POS100, POS1000 ARE OPTIONAL.

| | ; ; PARAMETER |
|---|---|
| | ORDINAL IS OPTIONAL |
| (OPT ( | ; ; IF POS1000 IS |

SPECIFIED, SAY :

“ < POS1000 > TAUSEND”

( POS1000 GIVEN )
( NUM1000 (

( CAT NUMERAL - 1 −9 )

; ; THE PREFIX1 ATTRIBUTE DISTINGUISHES
“ EIN “ - FROM “ EINS ”

( PREFIX1 TRUE )
( POS1 { \hat{ }2 POS1000} )

) )
( THOUSAND ( ( LEX “ TAUSEND ” ) ) )

) )

( OPT (

“ < POS100 > HUNDERT “

( POS 100 GIVEN )
( ALT (

( ( POS 100 ZERO ) )
( ( NUM100 (

( CAT NUMERAL -1 −9 )
( PREFIX1 TRUE )
( POS1 { \hat{ }2 POS 100 } )

) )

( HUNDRED ( ( LEX “ HUNDERT “ ) ) )

The above grammatical description may be used to obtain the correct German expression for an announcement such as “turn right in 350 meters”, (etc.

Use of functional unification grammars (“FUGs”) in text-generation is known in a large variety of implementations. In one example of an implementation of the invention using FUGs, the grammar is a language-specific, machine-readable grammar having no executable code. The grammar includes functional descriptions of speech fragments on the basis of which the correct sequence of words having the information content corresponding to the predetermined event is generated, thus allowing the building of grammatically correct sequences of words by the universal speech driver. By way of example, in order to produce an appropriate announcement or instruction for the following parameters, the corresponding grammar may define the transformation rules to obtain a morpheme sequence for the event: “turn right”, “300”, “meters”. The grammar may then determine the correct phrase such as “turn right in 300 meters”. When using FUGs, an expression may be described by its functional descriptions, each description having a plurality of descriptors. The descriptor may be a constituent set, a pattern or a feature. FUGs are well-known, one formalism being introduced by Michael Elhadad.

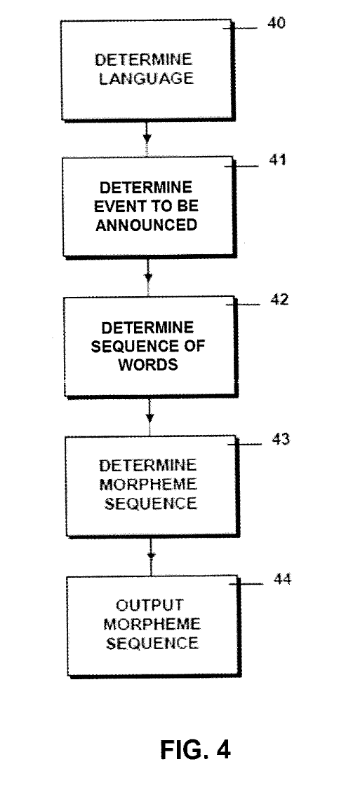

FIG. 4 illustrates a flowchart showing example steps for generating a speech output in different languages using a universal speech driver. In a first step 40 the language in which the announcement is output is determined. In one example of an implementation, the language is a default value determined when the language generating system is manufactured or installed. In such an implementation, the language may be changed during operation of the language generating system.

Once the language is determined 40, data corresponding to the event or parameter to be announced to the user is determined 41. As mentioned above, the grammar data may include transformation rules for obtaining the correct sequence of words or the correct sequence of morphemes corresponding to the event. For example, the event or parameter may be that the user of the system will reach the destination in 300 meters. When the data corresponding to the event is determined, the universal speech engine 21 may determine a corresponding sequence of words to use, step 42. To this end the universal speech driver 21 may access the grammar data 24 for the determined language in order to produce a grammatically correct sequence of words. In the case that pre-recorded speech fragments 25 are used, a morpheme sequence corresponding to the determined sequence of words may be determined in step 43. Subsequently, the morpheme or word sequence may be output orally to the user 44 via a loudspeaker 27, or alternatively, visually via a display.

In an example of an implementation, steps 42 and 43 may be combined into a single step. For example, using functional unification grammar, a sequence of morphemes may be generated without first generating the corresponding sequence of words. Alternatively, or in addition, the grammar may be designed in such a way that the grammar generates plain text or the phonetic transcription in dependence of an input parameter.

As may be seen from the above description, the invention provides a possibility to produce announcements in different languages with the use of one universal speech driver. It is contemplated that the disclosed language generating method system may be used in vehicle multimedia system, and the predetermined events correspond to announcements or instructions to a driver. The contemplated multimedia system may include a navigation unit guiding the user to a predetermined destination by outputting guiding announcements or instructions. The announcements or instructions may be acoustic or textual driving recommendations of the vehicle navigation system such as, for example, “turn right in 200 meters” or “turn left at the next traffic light”. The announcements or instructions may also include information relating to the operating status of the vehicle or navigation system such as “the route has been calculated” or “a new route will be calculated due to detour.”

The disclosed language generating method and LGS may be used in contexts other than in a vehicle multimedia system. For example, the system may be utilized to provide instructions or recommendations to a player while playing a video game, or to a user performing other functions such as a self-serve grocery check out, an ATM, an automated gas station, or other automated tasks or activities where directions may be useful.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A Language Generating System (“LGS”) for generating an output natural language data for informing a user of a predetermined event, where the output natural language data includes language data in at least one language from a plurality of different languages, the LGS comprising:
a data base where the data base includes, for each language, a grammar and where the grammar includes transformation rules for obtaining a sequence of words having an information content corresponding to the predetermined event;
a universal speech driver, where the universal speech driver is capable of building, for each of the different languages, the sequence of words having the information content corresponding to the predetermined event on the basis of the grammar; and
an information unit, where the information unit is capable of informing the user of the determined sequence of words.

2. The LGS according to claim 1, further including a Text-To-Speech engine which converts the sequence of words into the speech output.

3. The LGS according to claim 1, wherein the predetermined event corresponds to an announcement of a vehicle multimedia system.

4. The LGS according to claim 1, further including predetermined speech fragments for each language, wherein the universal speech driver is capable of building the sequence of words based on the speech fragments.

5. The LGS according to claim 4, further including a Text-To-Speech engine which converts the sequence of words into the speech output.

6. The LGS according to claim 1, further including a speech engine using the sequence of words for generating a natural language speech output in any of the languages from the plurality of different languages.

7. The LGS according to claim 6, further including predetermined speech fragments for each language, wherein the universal speech driver is capable of building the sequence of words based on the speech fragments.

8. The LGS according to claim 7, wherein the speech fragments are morphemes.

9. The LGS according to claim 8, further including a Text-To-Speech engine which converts the sequence of words into the speech output.

10. The LGS according to claim 9, wherein the predetermined event corresponds to an announcement of a vehicle multimedia system.

11. The LGS according to claim 10, wherein the announcement is an acoustic driving recommendation of a vehicle navigation system or an acoustic information about an operating status of the vehicle navigation system.

12. The LGS according to claim 11, wherein the grammar is a language specific functional unification grammar including functional descriptions of speech fragments, on the basis of which the correct sequence of words having the information content corresponding to the predetermined event is generated.

13. The LGS according to claim 12, further including
a language identifier which is capable of identifying the language of the speech data to be output and transmitting the language information to the universal speech driver,
where the speech driver is capable of selecting the corresponding grammar and the corresponding speech fragments for building the correct sequence of words.

14. A navigation system for guiding a user to a predetermined destination, the navigation system comprising:
a route determination unit, where the route determination unit is capable of determining a route to a predetermined destination;
a Language Generating System (“LGS”) for generating an output natural language data for informing a user of a predetermined event, where the output natural language data includes language data in at least one language from a plurality of different languages, the LGS comprising
a data base where the data base includes, for each language, a grammar and where the grammar includes transformation rules for obtaining a sequence of words having an information content corresponding to the predetermined event,
a universal speech driver, where the universal speech driver is capable of building, for each of the different languages, the sequence of words having the information content corresponding to the predetermined event on the basis of the grammar, and
an information unit, where the information unit is capable of informing the user of the determined sequence of words;
an information unit, where the information unit is capable of informing the user of the generated natural language.

15. A method for informing a user of a navigation system of a predetermined event by outputting natural language data, the method comprising:
determining the natural language in which the language data are to be output;
determining a sequence of words having an information content corresponding to the predetermined event based on a grammar of the determined language, the grammar including transformation rules for obtaining the correct sequence of words having the information content; and
informing the user of the sequence of words in the determined language.

16. The method according to claims 15, wherein for determining the sequence of words, a sequence of pre-recorded speech fragments is determined, the sequence of pre-recorded speech fragments being output as speech data.

17. The method according to claim 15, wherein the user is informed of the sequence of words by generating a natural language output including the determined sequence of words.

18. The method according to claim 17, wherein the speech output is produced from the generated sentence via a text-to-speech engine.

19. The method according to claims 17, wherein for determining the sequence of words, a sequence of pre-recorded speech fragments is determined, the sequence of pre-recorded speech fragments being output as speech data.

20. The method according to claim 19, wherein the output language data corresponds to an announcement of the navigation system, the announcement being acoustic driving recommendations or an information about an operating status of the navigation system.

21. The method according to claim 20, wherein the speech output is produced from the generated sentence via a text-to-speech engine.

22. The method according to claim 20, wherein the output language data corresponds to an announcement of the navigation system, the announcement being acoustic driving recommendations or an information about an operating status of the navigation system.

23. The method according to claim 22, wherein the pre-recorded speech fragments are recorded, for each language, from a native speaker.

24. The method according to claim 23, wherein the speech output is produced from the generated sentence via a text-to-speech engine.
